(19) United States
(12) Patent Application Publication
(10) Pub. No.: US 2001/0043206 A1
(43) Pub. Date: Nov. 22, 2001

(54) Display control device

(76) Inventors: Masahiro Naito, Tokyo (JP); Shuji Sotoda, Tokyo (JP); Takuji Kurashita, Tokyo (JP); Kazuhiro Sugiyama, Tokyo (JP)

Correspondence Address: BIRCH STEWART KOLASCH & BIRCH, PO BOX 747, FALLS CHURCH, VA, 22040-0747, US

(21) Appl. No.: 09/851,348

(22) Filed: May 9, 2001

(30) Foreign Application Priority Data
May 19, 2000 (JP) 147272/00

(51) Int. Cl. G09G 5/00

(52) U.S. Cl. 345/204

(57) ABSTRACT

In order to reduce the power consumed by the circuit when the image data is transferred to a memory in a display means, a write region detecting means 8 is provided to detect the address region in the graphics memory 2 accessed for writing by the image data writing means 1, and only such data that is within the region including the addresses accessed by the writing means 1 is transferred to the memory 5 in the display means 4. The region including the accessed addresses may for example a rectangular region of from the minimum vertical direction address to the maximum vertical direction address Y among the accessed addresses, and from the minimum horizontal direction address to the maximum horizontal direction address among the accessed addresses.

### BACKGROUND OF THE INVENTION

The present invention relates to a display control device, and in particular to a liquid crystal display control device for a portable equipment or the like.

FIG. 9 shows a display control device of a command control type. In FIG. 9, reference numeral 1 denotes an image data writing means including a CPU provided with an address bus, a data bus, and control lines. Reference numeral 2 denotes a graphics memory storing write data from the image data writing means 1. Reference numeral 3 denotes a data transfer means for reading, from the graphics memory 2, image data having been written by the image data writing means 1, and transferring the data to a display means 4. The display means 4 displays images, and includes a memory 5, a liquid crystal driver circuit 6 and a liquid crystal panel 7. The memory 5 stores image data for one screen of N dots (arranged in the horizontal direction)×M lines (arranged in the vertical direction) (N and M being positive integers) transferred from the data transfer means 3. The liquid crystal driver circuit 6 reads the data from the memory 5 responsive to clocks in synchronism with a display frequency, and drives the liquid crystal panel 7. The liquid crystal panel 7 is driven by the liquid crystal driver circuit 6 to display the image data.

In the display control device described above, as shown in FIG. 10, the image data for one screen is written from the image data writing means 1 such as a CPU or the like in the graphics memory 2. In this instance, not the entire screen of data is written, but only such part (pixels) of the screen of data that needs to be updated is rewritten. The data written represents images, characters, or the like. The image data in the graphics memory 2 is read by the data transfer means 3 sequentially from the address 0 to address N×(M−1). The data read is output to the display means 4, after addition of a command setting the horizontal address and the vertical address of the write region, e.g., a command as shown in FIG. 11. The display means 4 decodes the input command, and writes one screen of data in the region of from address 0 to address N×(M−1) in the memory 5. The data for one screen having been written in the memory 5 is read by the liquid crystal driver circuit 6 responsive to clocks in synchronism with the frame frequency of the liquid crystal display by the liquid crystal panel 7, and liquid crystal driving waveforms are thereby generated, and images are displayed by the liquid crystal panel 7.

Since the conventional display control device is configured as described above, when the data is transferred to the memory 5, one screen of data is transferred every time (every frame period). As a result, even when the data written from the image data writing means 1 to the graphics memory 2 is updated with regard to a small area of the screen, the transfer means 3 transfers the entire screen of data from the graphics memory 2 to the memory 5. The amount of power consumption of the circuit operating for the data transfer is the same as that required for rewriting the entire screen, so that the efficiency is low, and the useless power consumption occurs.

### SUMMARY OF THE INVENTION

The invention has been made to solve the problems described above, and its object is to reduce the power consumption required by the circuit for transferring image data to the memory of a display means.

According to the present invention, there is provided a display control device including an image data writing means, a graphics memory connected to the writing means, a data transfer means responsive to a command from the writing means for reading data from the graphics memory, and transferring data to a display means, and a write region detection means responsive to addresses accessed by the image data writing means for detecting a region including all the addresses, wherein when the image data writing means issues a transfer command, said transfer means transfers to the display means only such data that is in the region detected by said write region detecting means.

With the above arrangement, it is possible to reduce the amount of data that is transferred, so that the power consumed by the circuit when the data transfer means transfers the image data to the display means.

The region detecting means may be adapted to detect, as said write region, the region from the minimum vertical direction address and the maximum vertical direction address among the addresses accessed by said image writing means.

With the above arrangement, the extent of the write region is defined in a simple manner, so that it is possible to simplify the configuration of the circuit of the write region detecting means, and the power consumed by the write region detecting means can be reduced.

The region detecting means may be adapted to detect, as said write region, the region from the minimum vertical direction address to the maximum vertical direction address among the addresses accessed by said image writing means, and from the minimum horizontal direction address to the maximum horizontal direction address among the addresses accessed by said image writing means.

With the above arrangement, the amount of data transferred can be further reduced, so that the power consumed by the circuit when the data transfer means transfers the image data to the display means can be further reduced.

The region detecting means may alternatively be adapted to detect, as said write region, a rectangular region from the minimum vertical direction address to the maximum vertical direction address among the addresses accessed by said image writing means, and from a minimum horizontal direction address to the maximum horizontal direction address of a screen.

With the above arrangement, the amount of power consumed by the circuit when the data transfer means transfers the image data to the display means is reduced. Moreover, the circuit configuration of the write region detecting means is simplified, so that the power consumed by the circuit when the write addresses are detected can be reduced.

### BRIEF DESCRIPTION OF THE DRAWINGS

In the drawings:

FIG. 1 is a block diagram showing a display control device of Embodiment 1 of the present invention;

FIG. 2 is a diagram showing an example of write addresses for the graphics memory in Embodiment 1 of the present invention;

FIG. 3 is a diagram showing the procedure of write region detection and subsequent data transfer in Embodiment 1 of the present invention;

FIG. 4 is a diagram showing the manner of data transfer to the display means in Embodiment 1 of the present invention;

FIG. 5 is a block diagram showing a display control device of Embodiment 2 of the present invention;

FIG. 6 is a diagram showing an example of write addresses for the graphics memory in Embodiment 2 of the present invention;

FIG. 7 is a diagram showing the procedure of write region detection and subsequent data transfer in Embodiment 2 of the present invention;

FIG. 8 is a diagram showing the manner of data transfer to the display means in Embodiment 2 of the present invention;

FIG. 9 is a block diagram showing the configuration of a conventional display control device;

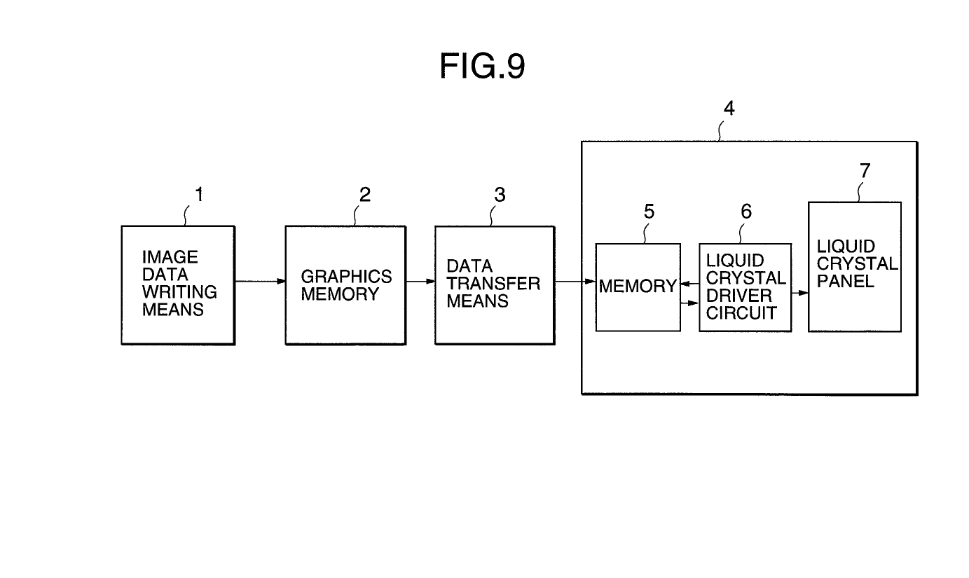

FIG. 10 is a diagram showing the configuration of a graphics memory in a conventional display control device, and the manner of reading; and

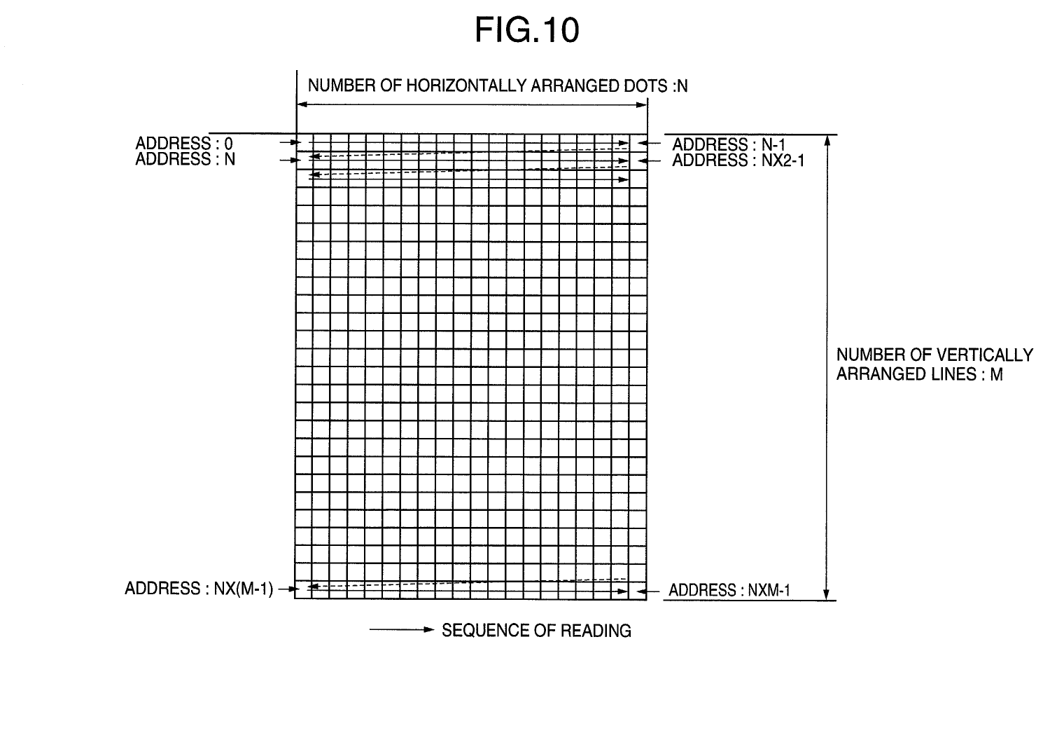

FIG. 11 is a diagram showing the manner of data transfer to the display means in the conventional display control device.

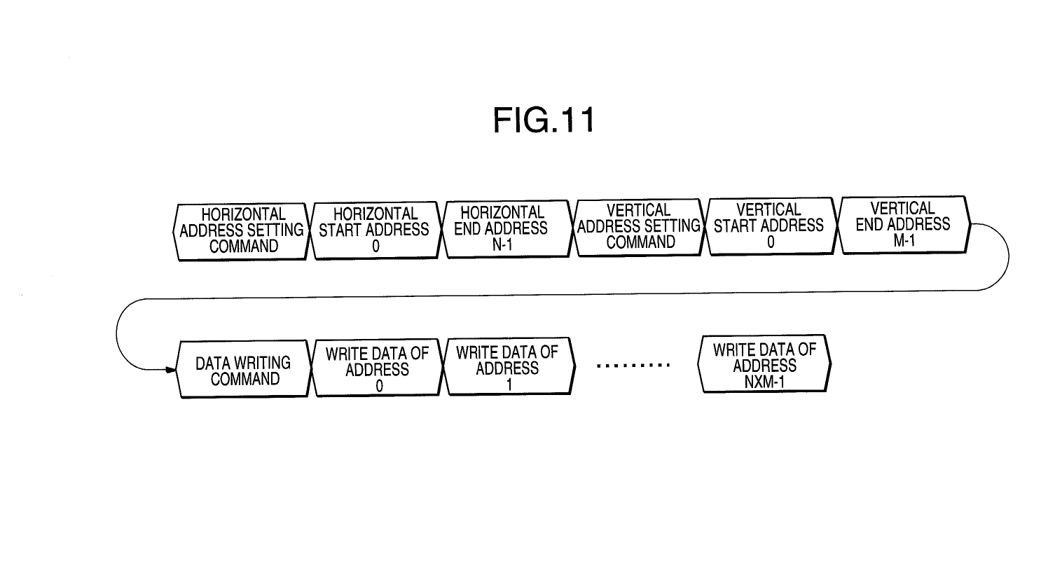

### DETAILED DESCRIPTION OF THE EMBODIMENTS

Embodiments of the invention will now be described with reference to the drawings. Embodiment 1.

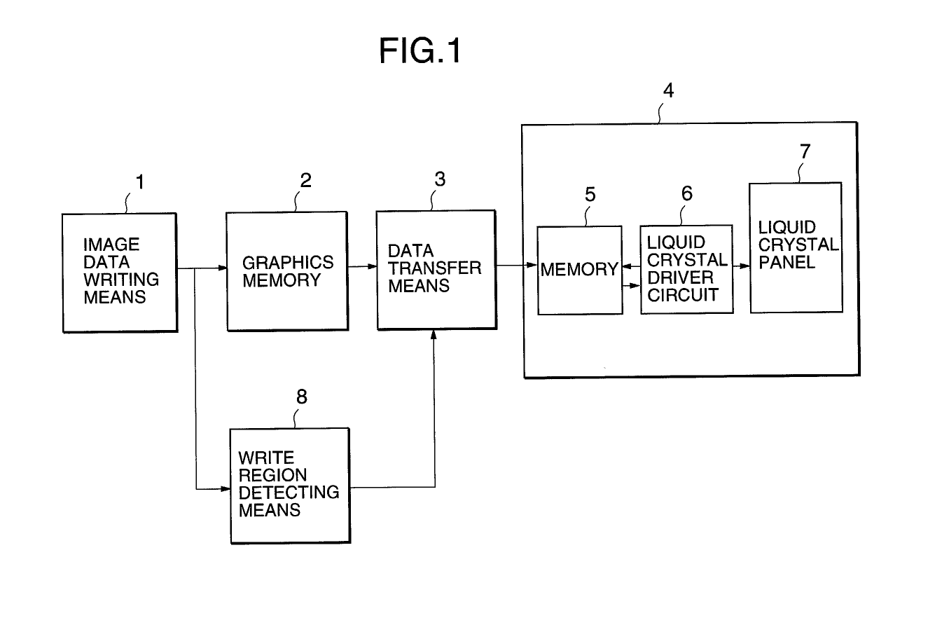

FIG. 1 shows a display control device of Embodiment 1 of the invention. In the drawing, reference numeral 1 denotes an image data writing means including a CPU provided with an address bus, a data bus, and control lines. Reference numeral 2 denotes a graphics memory which stores write data from the image data writing means 1, and is formed of N dots (arranged in the horizontal direction) by M lines. Reference numeral 3 denotes a data transfer means for reading image data from the graphics memory 2 in accordance with region information from write region detecting means 8, and transferring the data to a display means 4. Reference numeral 8 denotes a write region detecting means which detects the addresses accessed when the image data writing means 1 writes the data in the graphic memory 2, and outputs the region information thus detected, to the the data transfer means 3.

The display means 4 includes a memory 5, a liquid crystal driver circuit 6 and a liquid crystal panel 7. The memory 5 stores image data transferred from the data transfer means 3. The liquid crystal driver circuit 6 reads the data from the memory 5 responsive to clocks in synchronism with the display frequency, and drives the liquid crystal panel 7. The liquid crystal panel 7 is driven by the liquid crystal driver circuit 6 to display the image.

In the display control device configured as described above, image data formed of an arbitrary number of dots is written from the image data writing means 1 such as a CPU or the like, in the graphics memory 2. Rather than the entire screen of data, such data of only a part (pixels) that need to be updated is re-written. The write region detecting means 8 receives the signals sent over the address bus and control signal lines from the image data writing means 1, and detects the addresses in the graphics memory 2 in which the data is to be written.

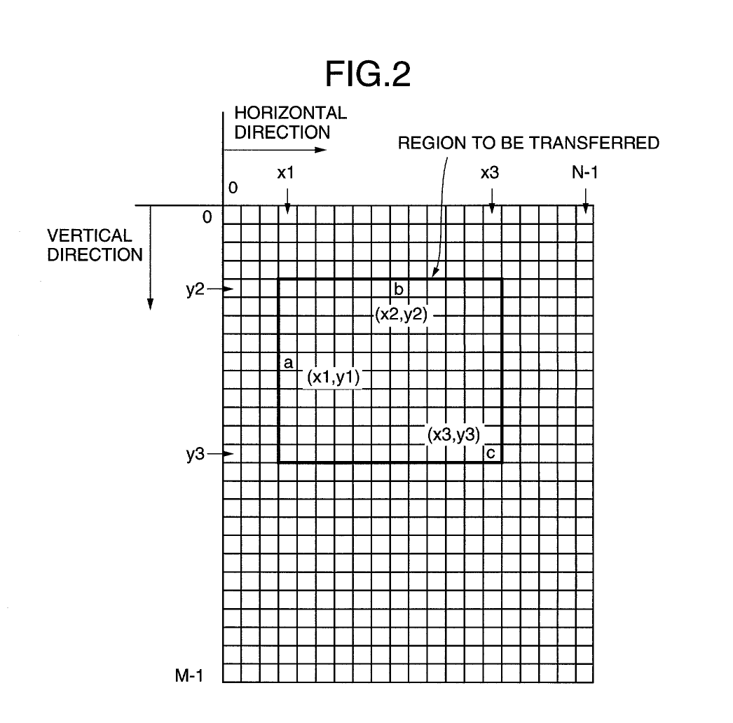

The operation of the write region detecting means 8 will next be described. It is assumed that in a certain frame period, data a, b and c are written at the addresses (x1, y1), (x2, y2) and (x3, y3), respectively, in the graphics memory 2, as shown in FIG. 2. Here, x1, x2, x3, y1, y2, and y3 are positive integers, and are related as follows:

x1<x2<x3, and

y2<y1<y3.

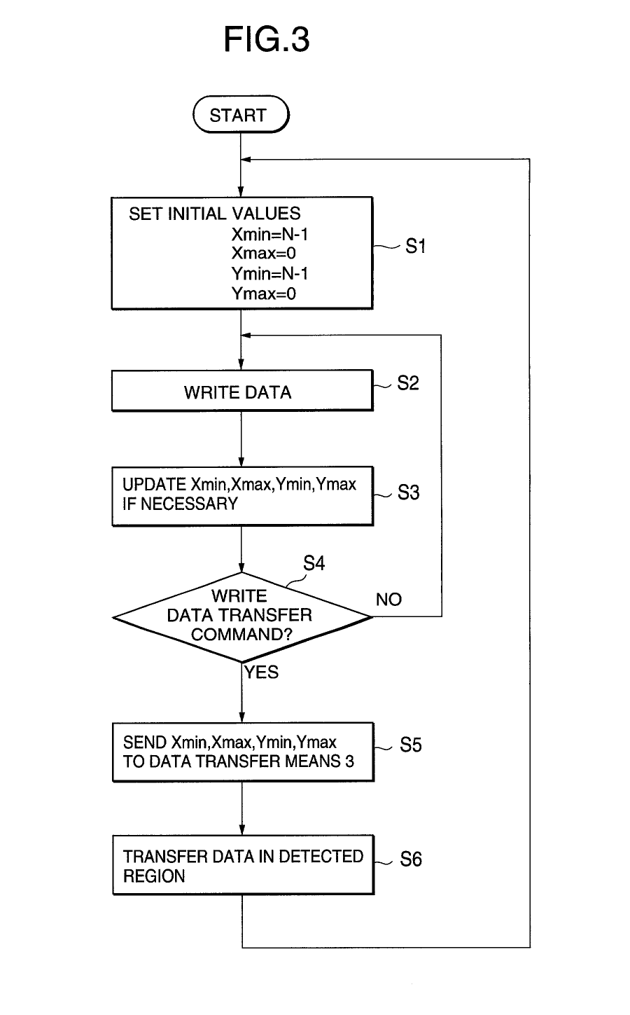

Moreover, a, b and c represent image or character data, and are for example positive values representing R, G and B data. Furthermore, the horizontal direction minimum value among the detected addresses (minimum horizontal direction address) is represented by Xmin, the horizontal direction maximum value among the detected addresses (maximum horizontal direction address) is represented by Xmax, the vertical direction minimum value among the detected addresses (minimum horizontal direction address) is represented by Ymin, and the vertical direction maximum value among the detected addresses (maximum vertical direction address) is represented by Ymax. The procedure for finding the values of Xmin, Xmax, Ymin and Ymax is shown in FIG. 3.

First, the initial values of Xmin, Xmax, Ymin and Ymax are set such that Xmin=N−1, Xmax=0, Ymin=M−1, and Ymax=0 (S1). Next, when writing in the graphic memory 2 by means of the image data writing means 1 is performed (S2), the write region detecting means 8 compares the write addresses in accordance with the signals supplied via the address bus and the control signal lines, and performs updating if necessary (S3). This operation is continued until the image data writing means 1 issues a data transfer command (S4). As a result of the above operations, the four coordinate values Xmin=x1, Xmax=x3, Ymin=y2, and Ymax=y3 are detected (such a case is assumed) immediately before the data transfer command is issued.

When the data transfer command is issued from the image data writing means 1, the write region detecting means 8 outputs the detected addresses Xmin=x1, Xmax=x3, Ymin=y2, and Ymax=y3 to the data transfer means 3 (S5). After outputting the detected addresses, the write region detecting means 8 sets the detected addresses to initial values in order to detect the write region of image data for the next screen (frame), and repeats the operation similar to that described above.

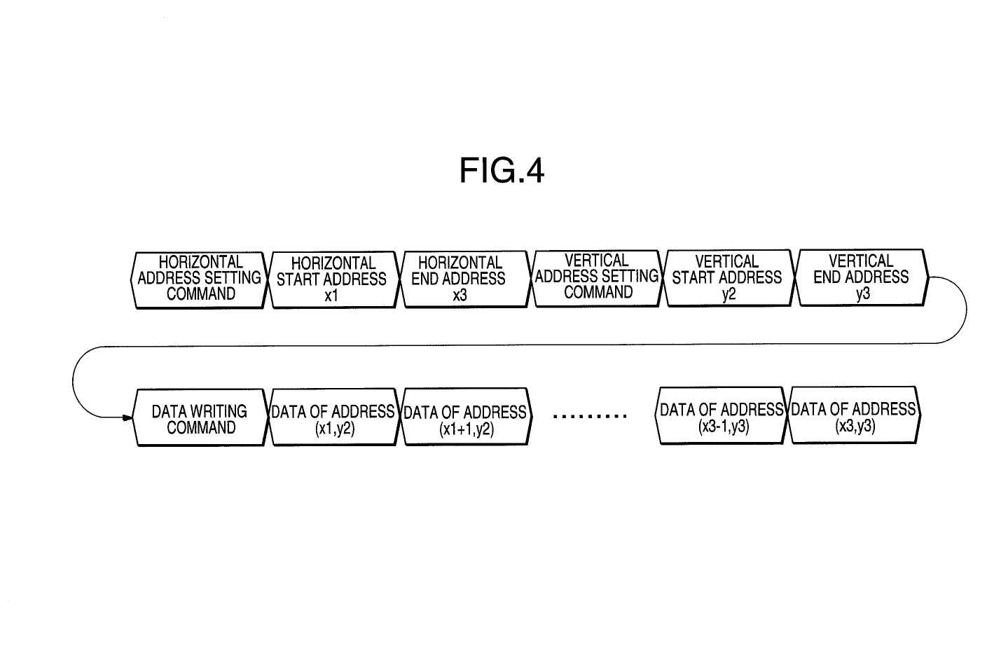

When the data transfer means 3 receives the detected addresses Xmin=x1, Xmax=x3, Ymin=y2, and Ymax=y3 from the write region detecting means 8, it transfers the image data within the rectangular region defined by the detected addresses, to the memory 5 (S6). That is, it generates a command setting the write region, as shown in FIG. 4, reads the image data in the rectangular region surrounded by (x1, y2), (x3, y2), (x1, y3) and (x3, y3), and outputs the read image data following the command setting the write region.

The display means 4 decodes the input command, and writes the data read from the graphics memory 2 in the rectangular region in the memory 5 defined by (x1, y2), (x3, y2), (x1, y3) and (x3, y3). When the transfer of data within the detected region is completed, it waits for the next data transfer command, and repeats the operation similar to that described above.

The data rewritten partially in the memory 5, together with the data in the other region already in the memory 5 is read, as data for one screen, by the liquid crystal driver circuit 6 responsive to the clocks in synchronism with the frame frequency of the liquid crystal display of the liquid crystal panel 7, and the liquid crystal driver circuit generates liquid crystal driving waveforms, causing the liquid crystal panel to display.

As has been described, by means of the write region detecting means 8 which detects the region in the graphics memory 2 accessed for writing by the image data writing means 1, the rectangular region of from the minimum vertical direction address Ymin to the maximum vertical direction address Ymax among the addresses accessed by the image data writing means 1, and from the minimum horizontal direction address Xmin to the maximum horizontal direction address Xmax among the addresses accessed by the image data writing means 1 is detected as the write region, and the data transfer means 3 is responsive to the detected region information for transferring only such data that have been rewritten, to the display means 4. For this reason, it is possible to reduce the power consumed by the circuit when the data transfer means 3 transfers the image data to the memory 5 in the display means 4.

Embodiment 2

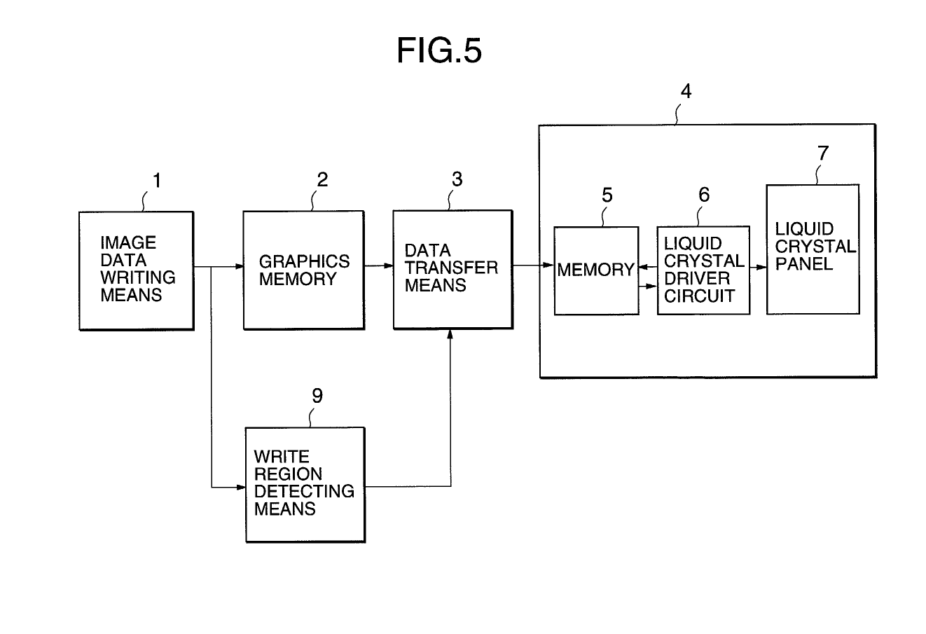

FIG. 5 shows a display control device of Embodiment 2 of the present invention. The display control device of Embodiment 2 is similar to the display control device of FIG. 1, but is provided with a write region detecting means 9 in place of the write region detecting means 8 of FIG. 1. Whereas the write region detecting means 8 of FIG. 1 detects, as the write region, a rectangular region from the minimum vertical direction address Ymin to the maximum vertical direction address Ymax among the addresses accessed by the image data writing means 1, and from the minimum horizontal direction address Xmin to the maximum horizontal direction address Xmax among the addresses accessed by the image data writing means 1, the write region detecting means 9 of FIG. 5 detects, as the write region, a rectangular region from the minimum vertical direction address Ymin to the maximum vertical direction address Ymax among the addresses accessed by the image data writing means 1, and from the minimum horizontal direction address 0 and the maximum horizontal direction address (N−1) among the addresses of the screen. In other words, it detects, as the write region, a plurality of consecutive lines. Since the minimum horizontal direction address 0 to the maximum horizontal direction address (N−1) among the addresses of the screen are known in advance, the write region detecting means 9 detects only the minimum vertical direction address Ymin and the maximum vertical direction address Ymax.

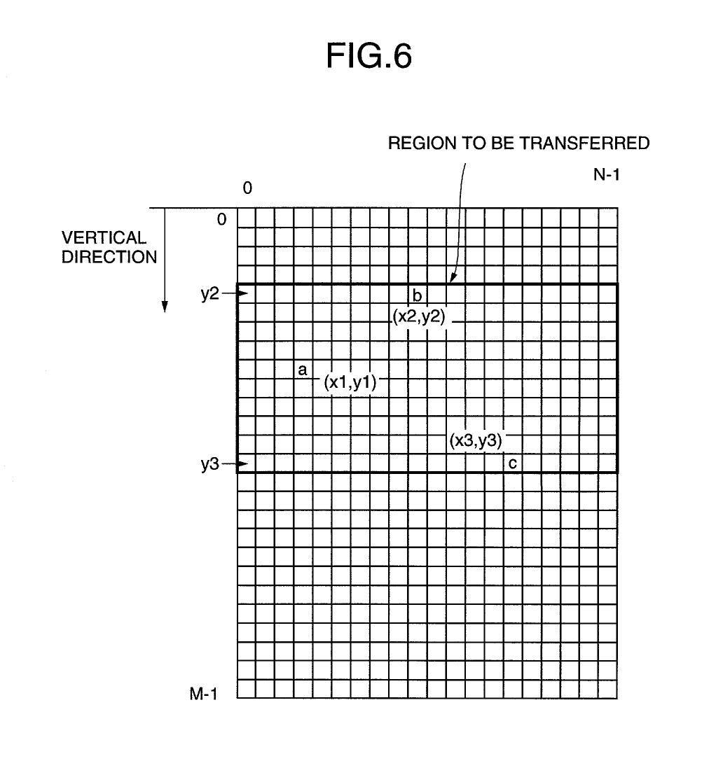

The operation of the write region detecting means 9 will next be described. For instance, it is assumed that, in a certain frame period, data a, b, and c are respectively written in the addresses (x1, y1), (x2, y2), (x3, y3) in the graphics memory 2 as shown in FIG. 6, as in Embodiment 1. Also as in Embodiment 1, x1, x2, x3, y1, y2, and y3 are positive integers, and related as follows:

x1<x2<x3, and

y2<y1<y3.

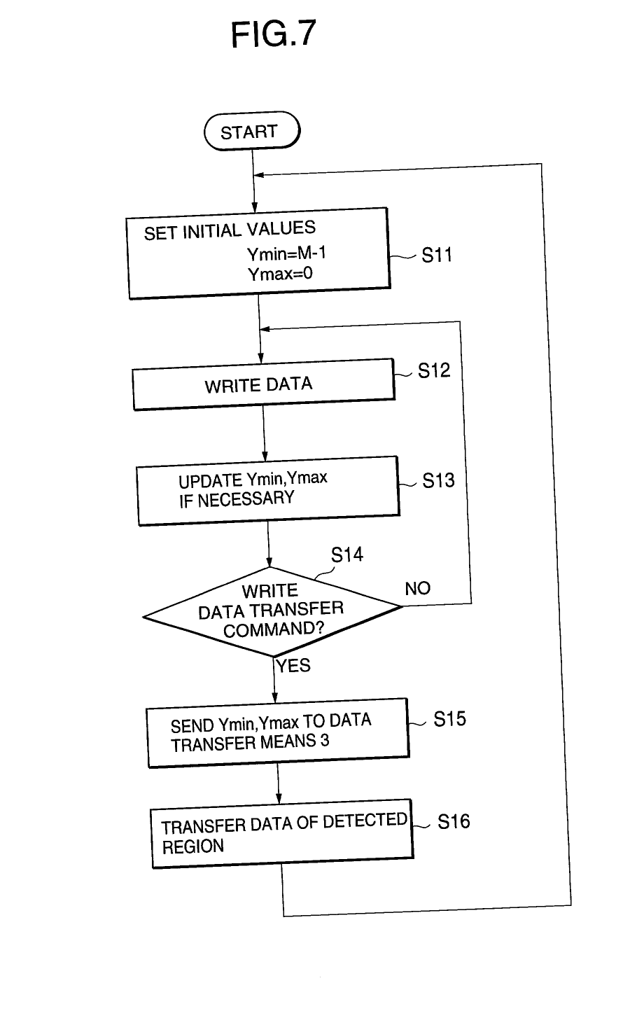

Moreover, a, b, and c represent image or character data, and are for example positive values representing R, G and B data. Furthermore, the vertical direction minimum value (minimum vertical direction address) and the vertical direction maximum value (maximum vertical direction address) among the detected addresses are respectively denoted by Ymin and Ymax. The procedure for finding Ymin and Ymax is shown in FIG. 7.

First, the initial values of Ymin and Ymax are set such that Ymin=M−1, and Ymax=0 (S11). Next, when writing in the graphic memory 2 by means of the image data writing means 1 is performed (S12), the write region detecting means 9 compares the write addresses in accordance with the signals supplied via the address bus and the control signal lines, and performs updating if necessary (S13). This operation is continued until the image data writing means 1 issues a data transfer command (S14). As a result of the above operations the two coordinate values Ymin=y2, and Ymax=y3 are detected (such a case is assumed) immediately before the data transfer command is issued.

When the data transfer command is issued from the image data writing means 1, the write region detecting means 9 outputs the detected addresses Ymin=y2, and Ymax=y3 to the data transfer means 3 (S15). After outputting the detected addresses, the write region detecting means 9 sets the detected addresses to initial values in order to detect the write region of image data for the next screen (frame), and repeats the operation similar to that described above.

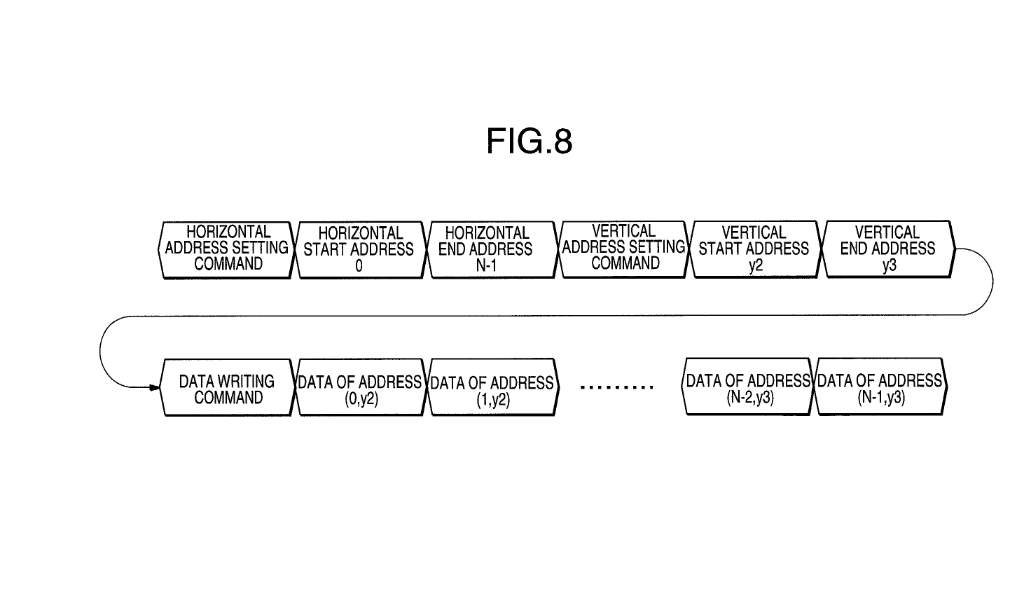

When the data transfer means 3 receives the detected addresses Ymin=y2, and Ymax=y3 from the write region detecting means 9, it transfers the image data within the rectangular region formed of the plurality of lines defined by the detected addresses, to the memory 5 (S16). That is, it generates a command setting the write region, as shown in FIG. 8, reads the image data of the plurality of lines of from the line of address y2 to the line of address y3, i.e., the image data within the rectangular region surrounded by (0, y2), (N−1, y2), (0, y3) and (N−1, y3), and outputs the read image data following the command setting the write region.

The display means 4 decodes the input command, and writes the data read from the graphics memory 2 in the region in the memory 5 of from the vertical direction address y2 to y3. When the transfer of data within the detected region is completed, it waits for the next data transfer command, and repeats the operation similar to that described above. In other respects, the operation is similar to Embodiment 1.

As has been described, by means of the write region detecting means 9 which detects the region in the graphics memory 2 in which the image data writing means 1 writes, the rectangular region of from the minimum vertical direction address Ymin to the maximum vertical direction address Ymax among the addresses accessed by the image data writing means 1, and of from the minimum horizontal direction address 0 to the maximum horizontal direction address (N−1) among the addresses of the screen is detected as the write region, and the data transfer means 3 is responsive to the detected region information for transferring only such data that have been rewritten, to the display means 4. For this reason, it is possible to reduce the power consumed by the circuit when the data transfer means 3 transfers the image data to the memory 5 in the display means 4. Moreover, the write region detecting means 9, which detects the accessed region, needs to compare only the vertical direction addresses of the write addresses to detects only the two vertical direction addresses, i.e., the vertical direction minimum value Ymin and the vertical direction maximum value Ymax, so that the configuration of the circuit is simplified and the power consumed by the circuit when the write addresses are detected can be reduced.

What is claimed is:

1. A display control device including an image data writing means, a graphics memory connected to the writing means, a data transfer means responsive to a command from the writing means for reading data from the graphics memory, and transferring data to a display means, and a write region detection means responsive to addresses accessed by the image data writing means for detecting a region including all the addresses, wherein when the image data writing means issues a transfer command, said transfer means transfers to the display means only such data that is in the region detected by said write region detecting means.

2. The display control device as set forth in claim 1, wherein said region detecting means detects, as said write region, the region from the minimum vertical direction address and the maximum vertical direction address among the addresses accessed by said image writing means.

3. The display control means as set forth in claim 2, wherein said region detecting means detects, as said write region, the region from the minimum vertical direction address to the maximum vertical direction address among the addresses accessed by said image writing means, and from the minimum horizontal direction address to the maximum horizontal direction address among the addresses accessed by said image writing means.

4. The display control device as set forth in claim 2, wherein said region detecting means detects, as said write region, a rectangular region from the minimum vertical direction address to the maximum vertical direction address among the addresses accessed by said image writing means, and from a minimum horizontal direction address to the maximum horizontal direction address of a screen.
